(19) United States
(12) Patent Application Publication
(10) Pub. No.: US 2015/0017612 A1
(43) Pub. Date: Jan. 15, 2015

(54) METHODS AND SYSTEMS FOR COMMUNICATING COLORS TO AND FROM COLORBLIND PEOPLE

(71) Applicant: University of Southern Indiana, Evansville, IN (US)

(72) Inventor: Joseph Uduehi, Evansville, IN (US)

(21) Appl. No.: 14/367,514

(22) PCT Filed: Dec. 28, 2012
(86) PCT No.: PCT/US12/71963

§ 371 Date: Jun. 20, 2014

Related U.S. Application Data
(60) Provisional application No. 61/582,094, filed on Dec. 30, 2011.

(51) Int. Cl. G09B 21/00

(52) U.S. Cl. CPC G09B 21/003
USPC 434/112

(57) ABSTRACT

There are provided methods and systems of communicating colors to and from colorblind people using a colorblind spectrum based on the light reflections of the colors and a coding system to indicate the colors.

### BACKGROUND

This disclosure relates to methods and systems of communicating colors to and from colorblind people. More particularly, this disclosure relates to methods and systems of communicating colors using visual art techniques.

### SUMMARY

This disclosure includes a method for communicating colors to a colorblind person. The method includes creating an ordered set of eight colors selected from the group comprising or consisting of white, yellow, orange, green, blue, red, purple, and black; assigning a number from 0 to 7 to each of the eight colors based on light reflection of the color; exposing the colorblind person to the eight colors together with the assigned numbers; and printing at least one of the assigned numbers on an item to denote a corresponding color, wherein at least one of the assigned numbers is identifiable as the corresponding color.

### BRIEF DESCRIPTION OF THE DRAWINGS

The detailed description particularly refers to the accompanying figures in which: FIG. 1 shows a first embodiment of a method incorporating the use of a colorblind spectrum together with a gray-scale version of the colorblind spectrum. The top row (Rainbow Spectrum) is (left to right) red, orange, yellow, green, blue, indigo, and purple. The middle row (New Spectrum) is (left to right) yellow, orange, green, blue, red, and purple. The bottom row (New Spectrum with Neutrals) is (left to right) white, yellow, orange, green, blue, red, purple, and black.

FIG. 2 shows the colorblind spectrum in FIG. 1 [top row: (left to right) white, yellow, orange, green, blue, red, purple, and black] transformed into a black-and-white spectrum by the shading using grayscale (bottom row).

FIG. 3 shows the shaded colorblind spectrum flanked by a colored colorblind spectrum in which each color is provided a number sequentially from 0 to 7 to create an ordered set of eight colors.

FIG. 4 shows a chart explaining one embodiment in which a colorblind person is trained using the shaded colorblind spectrum and the colored colorblind spectrum.

FIG. 5 shows a color wheel formulated from the ordered set of eight colors and combinations of colors.

FIG. 6A is an exemplary scheme of modified numbers, which are correlated with shades of the colors.

FIG. 6B is another exemplary scheme of modified numbers, which are correlated with shades of the colors.

### DETAILED DESCRIPTION

To provide an overall understanding of the invention, certain illustrative embodiments will now be described. However, it will be understood by one of ordinary skill in the art that the systems and methods described herein can be adapted and modified for other suitable applications and that such other additions and modifications will not depart from the scope hereof.

The techniques and illustrative embodiments described herein can enable a colorblind person, as well as a person with normal color vision, to distinguish various colors. More specifically, the systems and methods described herein include systems and processes that code color information that is indistinguishable by a colorblind individual onto a channel of information that is detectable by the individual. Such systems and methods can allow a colorblind person to convey interest in a particular color to a normal (e.g., non-colorblind) person and can allow a normal person to convey interest in a particular color to a colorblind person.

In one illustrative embodiment, the colorblind person can be trained to decipher colors based on the shade of colors. In the colorblind spectrum of a first embodiment, the neutral colors of white and black lie at the ends of the spectrum. The spectrum then moves from extreme light values in white to the darkest values in black. In between the extreme colors, there are yellow, orange, yellow-green, green, blue and so forth.

As shown in FIG. 1, the method incorporates the use of a colorblind spectrum together with a gray-scale version of the colorblind spectrum. In the ordinary visible light spectra (rainbow spectrum), the colors are arranged by wavelength from highest to lowest as red, orange, yellow, green, blue, indigo, and purple In the colorblind spectrum (new spectrum), the colors of the visible light spectrum are first arranged lightest to darkest by reflection, i.e. yellow, orange, green, blue, red, and purple. Adding the neutrals (white and black), the spectrum of colors or “colorblind spectrum” from lightest to darkest is white, yellow, orange, green, blue, red, purple, and black. Accordingly, one embodiment includes an ordered set of eight colors selected from the group comprising or consisting of white, yellow, orange, green, blue, red, purple, and black.

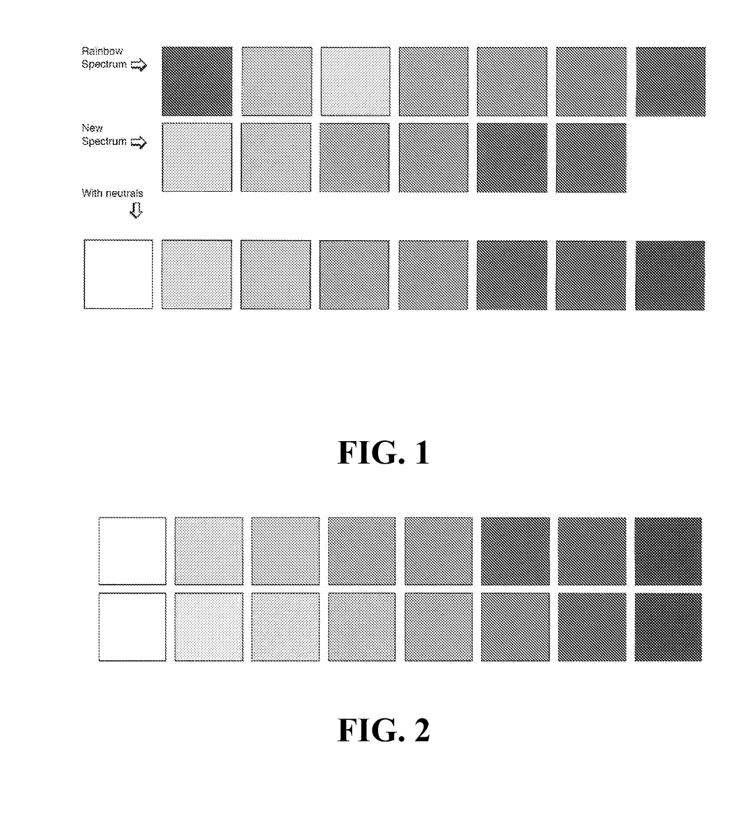

As shown in FIG. 2, the colorblind spectrum is then transformed into a black-and-white spectrum by using grayscale. The colorblind spectrum can be reproduced by adjusting the grayscale of the colors. One method for transforming the main colorblind spectrum into a spectrum of shades of colors is through the use a photocopier. In this exemplary method, a beam of light moves across the sheet of paper that has been placed on the copier's glass surface. Light is reflected from white areas of the paper and strikes the drum below and as a photon of light hits, electrons are emitted from the photoconductive atoms in the drum and neutralize the positive charges above. Dark areas on the original (such as pictures or text) do not reflect light onto the drum, leaving regions of positive charges on the drum's surface. The amount of light reflected can create the shading of the color scheme so to allow the shaded colorblind spectrum to come across.

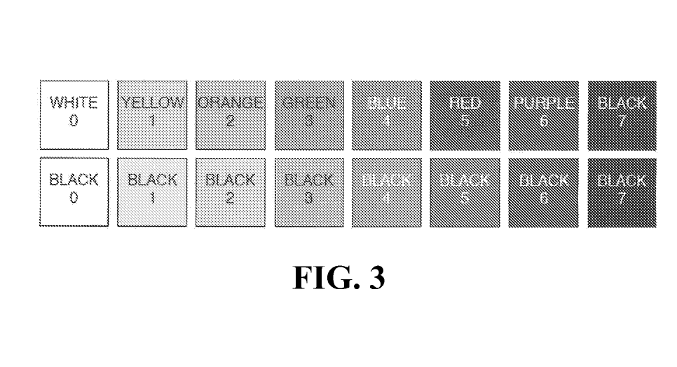

As shown in FIG. 3, the shaded colorblind spectrum is compared to the corresponding colored colorblind spectrum, and each color is provided a number sequentially from 0 to 7 or lightest to darkest. The colors in the colorblind spectrum and the shaded colorblind spectrum are also labeled according to their corresponding color or pre-shaded color. For example, white is labeled with number 0 in the colorblind spectrum and the shaded representation of white in the shaded colorblind spectrum is also labeled “white”; yellow is labeled with number 1 in the colorblind spectrum and the shaded representation of yellow in the shaded spectrum is also labeled “yellow”; and so forth. In this embodiment, associating (i) numbers with colors and shaded colors and (ii) names of colors and shaded colors provides a tool to be used to train a colorblind person with regard to the colors.

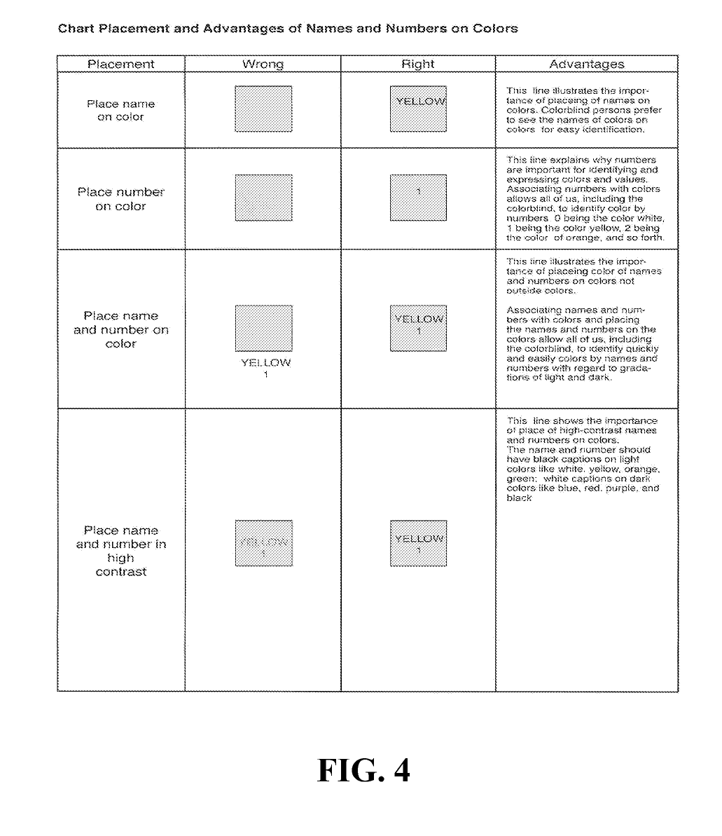

As shown in FIG. 4, through the use of the shaded colorblind spectrum together with the colored colorblind spectrum, a colorblind person may be trained to associate a color with a number and label. As a colorblind person can see both words and numbers, he or she can identify the color mentally from the words or numbers. For example, the association of color names and numbers together with the colors allows for a colorblind person to identify a color by name and/or number.

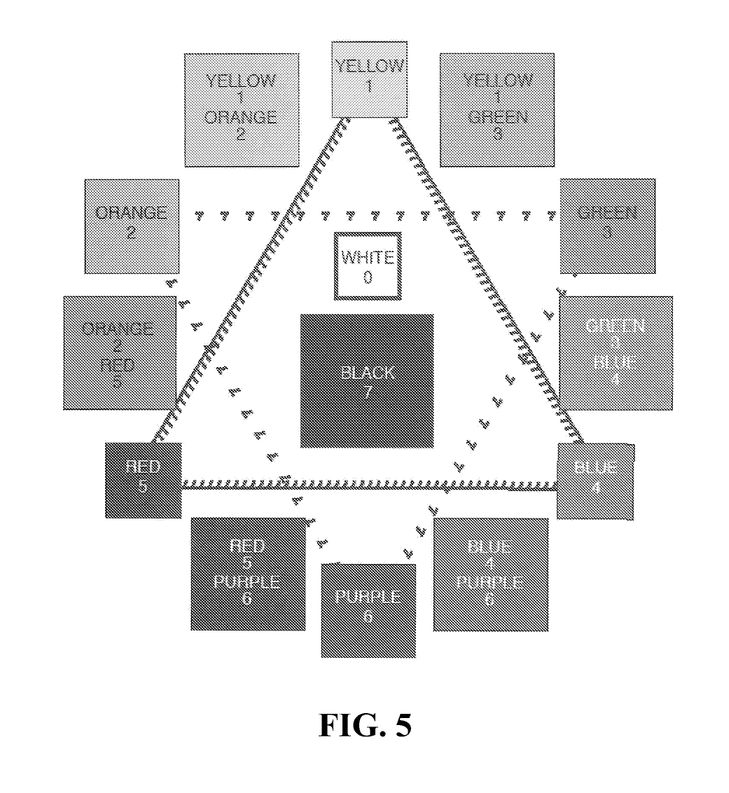

In operation and use, the method provides a colorblind color wheel for use with a person with colorblindness. As shown in FIG. 5, there can be a new color wheel with combinations of colors, which can teach a colorblind person to identify color(s) even if he or she cannot specifically see the color. In this embodiment, colors can be identified numerically as a combination of other colors. For example, the combination of yellow and orange can be identified as 1 and 2, whereas the combination of yellow and green can be referred to as 1 and 3.

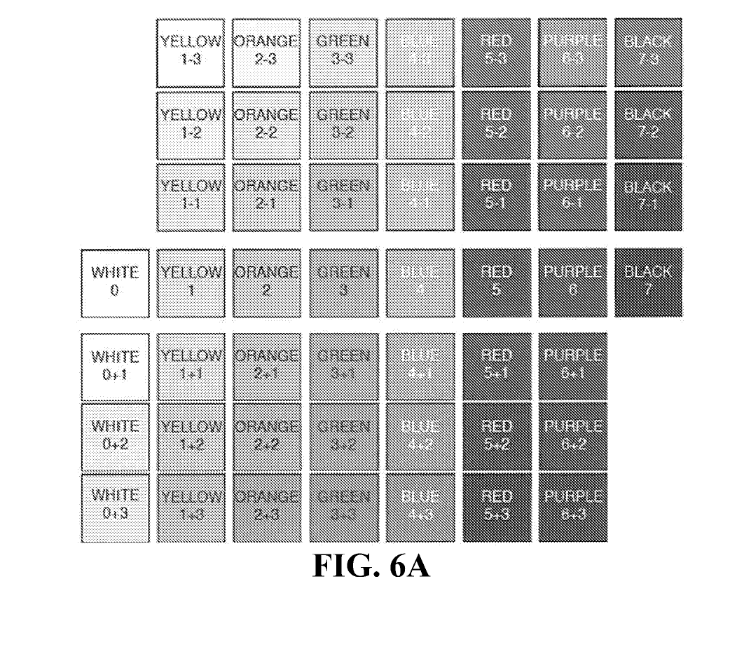

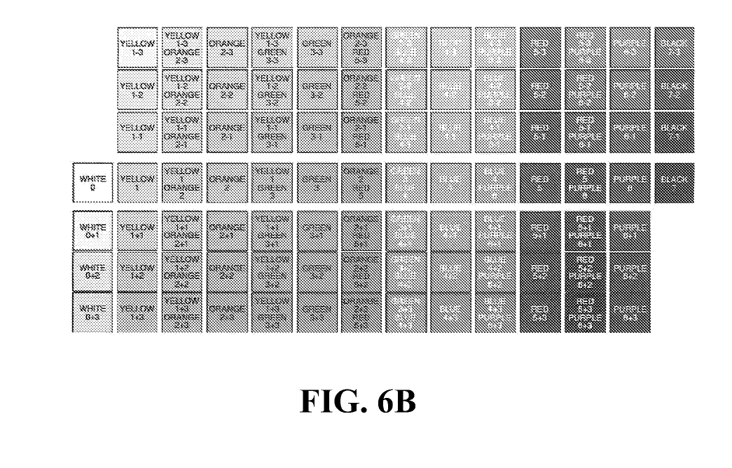

In another embodiment, the number in the colorblind spectrum can be modified by a second number from −7 to +7. In this embodiment, the plus and minus symbols with the integer reveal a range of hues or colors. Alternatively, the plus and minus symbols can be used to indicate only one level of brightness or darkness. In yet another alternative, many more shades of colors within the colorblind spectrum may be added and used. The charts shown in FIG. 6A and FIG. 6B are exemplary schemes for modified numbers, which are correlated with shades of the color.

In another embodiment, a number or combination of numbers from the number scheme or spectrum can be placed on an item to convey the color of the item to the colorblind. There is virtually no limit on the items that can be tagged with such a scheme. For example, clothing, books, maps, charts, and magazines may be tagged with a number so to allow the person to identify and understand the color of the item. Further examples include tagging items with a number such as colored containers, markers, storage units, crayons, paints, stains, and other colored items so to allow a person to identify the color of the item from the number or combination of numbers. It is contemplated that virtually any object or item may be tagged so to allow a person with colorblindness to identify the

In another embodiment, a method can be used to identify or receive user input representative of the type of color blindness to address. For example, the user may be diagnosed as having a specific colorblindness based on color/number selection. For example, specific shaded numbers may indicate red-green color blindness.

In another embodiment, the methods described herein aid color-vision impaired individuals by processing color-coded information that is not perceptible to these individuals and recoding the information in a media that is perceptible to the individuals, such as by recoding the color information onto a visually perceptible temporal pattern that is detectable by all sighted people. To this end, these systems recode color coded information to allow color vision impaired people to differentiate between colors, e.g., red and green.

Other embodiments include systems and methods described herein to provide alternate ways to visually present information and, in particular, color information to a user (e.g., a colorblind person). These systems have wide applicability, including for providing systems that make it easier for a colorblind person to distinguish color coded information presented in a pie chart, a graph, a map or in some other format. For illustration, a red line in a graph could be marked with the number “5”. By using numbers and/or words on such items, it is possible to convey the color to a person who is colorblind and vice versa.

Other embodiments include systems that can process color information in a manner that presents the information in a format that can be perceived by a person with impaired color-vision. To this end, the systems and method described herein, inter alia, provide a user (e.g., a colorblind person) with control over the color palette and hues being used to display information. By controlling the color, a user can redirect color coded information into a format that is more easily perceived by the user.

With this practice, the systems and methods described herein may be realized as a method to convey colors to a color-blind person. By placing codes or numbers on items, colorblind people can understand the color of the item even if the color cannot be optically seen by that person. For example, a stop sign may have the number “5”, and a colorblind person will recognize that the sign is red from the number “5.” For another example, a stoplight may have a “red-light” with the number 5 on it and a colorblind person, who may not see the red, can see the “5” and understand that the stoplight is red.

Appendix A of U.S. provisional application 61/582,094, incorporated by reference herein, includes specific examples of illustrative embodiments.

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

What is claimed is:

1. A method for communicating colors to a colorblind person, the method comprising the steps of:
creating an ordered set of eight colors comprising the colors white, yellow, orange, green, blue, red, purple, and black;
assigning a number from 0 to 7 in sequence to each of the eight colors in the ordered set based on light reflection of the color;
printing at least one of the assigned numbers on an item to denote a corresponding color,
wherein at least one of the assigned numbers is identifiable as the corresponding color, and
exposing the colorblind person to the eight colors together with the assigned numbers.

2. The method as claimed in claim 1, wherein the colorblind person can identify the color of the item from at least one of the assigned numbers that corresponds to a single color in the ordered set.

3. A color chart comprising a colored spectrum of white, yellow, orange, green, blue, red, purple, and black to form an ordered set of colors,
wherein the colors of the ordered set are arranged from lightest to darkest by reflection.

4. A color chart comprising a grey-scale spectrum of the color black to form an ordered set,
wherein the color values of the ordered set are arranged from lightest to darkest light reflections of the colors white, yellow, orange, green, blue, red, purple, and black, respectively.

5. (canceled)

6. The color chart of claim 3, wherein each of the colors of the ordered set are represented by eight sequential numbers, and
wherein each number in the sequence corresponds to a single color in the ordered set.

7. The color chart of claim 6, wherein the colors of the ordered set are represented by the numbers 0 through 7 in sequence.

8. The color chart of claim 3, wherein the colors of the ordered set are represented by the names of the colors.

9. The color chart of claim 3 claim 8, wherein the colors of the ordered set are represented by the names of the colors and the corresponding numbers.

10. The color chart of claim 6, wherein the colors of the ordered set are further represented by a second negative or positive number to indicate a lighter or darker hue of the color.

11. The color chart of claim 10, wherein a color comprising more than one color of the ordered set is displayed as a combination of the number representing each color of the ordered set that comprises the color.

12. The color chart of claim 21, wherein the color chart is represented by the color chart of FIG. 2 or FIG. 3.

13. The color chart of claim 10, wherein the color chart is represented by the color chart of FIG. 6A.

14. The color chart of claim 11, wherein the color chart is represented by the color chart of FIG. 6B.

15. A color wheel of FIG. 5.

16. The method of claim 1, wherein the number is assigned to each of the eight colors of the ordered set and wherein the number 0 is assigned to the color that reflects the most amount of light and the number 7 is assigned to the color that reflects the least amount of light.

17. The color chart of claim 15, wherein the color chart is represented by FIG. 5.

18. The color chart of claim 5, wherein the colored spectrum and the grey-scale spectrum are in a vertical orientation.

19. The color chart of claim 11, wherein the second number may range from −7 to +7.

20. The color chart of claim 19, wherein the (+) symbol represents one level of darkness and the (−) symbol represents one level of brightness.

21. The color chart of claim 3 comprising:
a grey-scale spectrum of eight black color values and
a colored spectrum of eight color values representing the colors white, yellow, orange, green, blue, red, purple, and black,
wherein the grey-scale spectrum color values correspond to the light reflections of the colors of the colored spectrum.
